(19) United States
(12) Patent Application Publication
(10) Pub. No.: US 2022/0072457 A1
(43) Pub. Date: Mar. 10, 2022

(54) VACUUM CLEANER FILTER BAG HAVING IMPROVED WELD SEAM STRENGTH

(71) Applicant: EUROFILTERS HOLDING N.V., Overpelt (BE)

(72) Inventors: Ralf SAUER, Overpelt (BE); Jan SCHULTINK, Overpelt (BE)

(21) Appl. No.: 17/414,732

(22) PCT Filed: Dec. 16, 2019
(86) PCT No.: PCT/EP2019/085368

§ 371 Date: Jun. 16, 2021

(30) Foreign Application Priority Data
Dec. 17, 2018 (EP) 18213001.3

(51) Int. Cl. B01D 39/16; A47L 9/14; B01D 46/02; B01D 46/00; B32B 27/36; B32B 5/02; B32B 5/26; B32B 27/12

(52) U.S. Cl. CPC B01D 39/1623; B32B 2432/00; B01D 46/02; B01D 46/0001; B32B 27/36; B32B 5/022; B32B 5/267; B32B 5/269; B32B 27/12; B01D 2239/0283; B01D 2239/0618; B01D 2239/1233; B01D 2239/1258; B01D 2239/1291; B01D 2239/0627; B01D 2239/0233; B01D 2239/10; B01D 2239/0654; B01D 2239/0672; B01D 2275/10; B01D 2279/55; B01D 2239/0622; B32B 2305/22; B32B 2262/0253; B32B 2262/0284; B32B 2272/00; B32B 2307/724; B32B 2307/72; B32B 2262/124; A47L 9/14

(57) ABSTRACT

The invention comprises a vacuum cleaner filter bag with a bag wall, comprising: a support layer comprising recycled polyethylene terephthalate, rPET; a fine filter layer of a meltblown non-woven fabric comprising polypropylene, PP, PET and/or recycled polypropylene, rPP; and a capacity layer of a non-woven fabric comprising rPET, recycled textile material, TLO, and/or rPP; wherein the bag wall moreover comprises at least one intermediate layer formed of a non-woven fabric or a fibrous web and comprising rPP as a main component; and wherein the at least one intermediate layer is arranged between the support layer and the fine filter layer and/or between the fine filter layer and the capacity layer.

The invention relates to a vacuum cleaner filter bag, in particular a vacuum cleaner filter bag having a bag wall, being at least partially made of recycled material.

Particularly sustainable and environmentally friendly vacuum cleaner filter bags can be made using textile waste (TLO, textile left overs) and/or recycled plastics. Examples of such filter bags are disclosed in WO 2018/065164 A1 and WO 2017/158026 A1.

With such vacuum cleaner filter bags, it is inevitable that both within one layer and from layer to layer of the non-woven fabric laminate, different and inhomogeneous basic materials are employed. For example, support layers are often formed of recycled polyethylene terephthalate, rPET, while the fine filter layer comprises, for example, polypropylene, PP, having a high melt-flow index, and the capacity layer comprises TLO. To achieve a preferably high proportion of recycled plastics, a preferably light fine filter layer is employed in many cases.

To interconnect the individual layers, an ultrasonic weld seam is typically created. In the process, longitudinal oscillations with frequencies of 20 kHz to 35 kHz and tool amplitudes of 5 μm to 50 μm are introduced into the non-woven fabrics to be connected under pressure. The frictional heat formed by the oscillations melts the material of the non-woven fabric. Upon completion of the introduction of sound, the material must briefly cool down under the still applied pressure for solidification. Thus, a weld seam capable of bearing will be formed within a short time.

However, non-woven fabrics rather have transmission properties unfavourable for ultrasonic energy. Non-woven fabrics with many pores have a high acoustic absorption factor due to their structure. For good welding results, it is therefore necessary that the materials to be connected are preferably matched to each other both with respect to their melting points and their chemical natures (amorphous/semi-crystalline). This is not always possible and turns out to be difficult in particular with the above-mentioned environmentally friendly vacuum cleaner filter bags of recycled materials.

To improve weld seam strength, various approaches have been already examined.

DE 20 300 781 U1, for example, discloses material strips of a thermoplastic material which can be arbitrarily arranged and are to reinforce the connecting seam. Such material strips, however, are difficult to position in the longitudinal, and in particular in the transverse direction.

EP 2 944 247 A1 discloses structures and dimensions for bag seams which achieve, in particular with high grammages, good strength properties.

None of the suggested solutions, however, offers a manufacture-friendly solution providing good weld seam strength in vacuum cleaner filter bags of different recycled materials.

It is therefore the object of the invention to provide a vacuum cleaner filter bag whose bag wall is made with sustainable plastics and whose weld seams have sufficient strength.

This object is achieved by a vacuum cleaner filter bag according to claim 1. Particularly advantageous developments can be found in the subclaims.

The inventors have surprisingly found that by an intermediate layer of a non-woven fabric or a fibrous web which comprises the recycled polypropylene, rPP, as a main component, an essential improvement of the weld seam strength can be achieved. The intermediate layer in particular leads to the support layer or the capacity layer to better connect to the fine filter layer, and the maximum tensile force of the weld seams is thus increased. The melt of the intermediate layer, which comprises rPP, here acts as a welding assistant between the layers.

If an intermediate layer between the support layer and the fine filter layer, and also an intermediate layer between the fine filter layer and the capacity layer, are arranged, the intermediate layer between the support layer and the fine filter layer can be referred to as “first intermediate layer”, and the intermediate layer between the fine filter layer and the capacity layer can be referred to as “second intermediate layer”. The intermediate layers can comprise corresponding features. Below, reference will therefore also be made to “at least one intermediate layer”. The corresponding features can then apply to one or all intermediate layers. Even more intermediate layers than the two mentioned herein can be provided.

According to a first example, the support layer can be a filament spunbond (also briefly referred to as “spunbond”) consisting of rPET, as an outer layer of the bag wall, and the fine filter layer can be a meltblown non-woven fabric consisting of virgin PP (new material). The capacity layer can in this example comprise TLO.

The term “comprises as a main component” means that the material of the at least one intermediate layer comprises more than 50%, in particular more than 70%, in particular more than 90% of rPP, or that the material of the intermediate layer consists of rPP. The term will also be used herein for other parts of the vacuum cleaner filter bag. In these cases, it correspondingly means that the material of the respective part comprises more than 50%, in particular more than 70%, in particular more than 90% of the indicated plastic, or that the material of the respective part consists of the indicated plastic.

The term “recycled plastic” used for the purposes of the present invention is to be understood as a synonym for “plastic recyclates”. For the definition of the terms, reference is made to Standard DIN EN 15347:2007.

So, the bag wall of the vacuum cleaner filter bag comprises an air permeable material which is composed of multiple layers. This is also referred to as a laminate. By using recycled plastics at least in the support layer, the capacity layer and the at least one intermediate layer, a clearly advantageous filter bag in terms of ecology is provided. In contrast to vacuum cleaner filter bags known from prior art, thus less or no fresh/pure (virgin) plastic material at all is used for the manufacture of the non-woven fabrics or fibrous webs forming the basis of the vacuum cleaner filter bag, but rather those plastics are predominantly or exclusively employed which had already been in use and have been recovered by corresponding recycling processes. By the at least one intermediate layer according to the invention, the weld seam strength is also improved compared to bags known from prior art.

Simultaneously, the at least one intermediate layer is part of the laminate of the bag wall, that means in other words, it represents a complete layer of the bag wall. The at least one intermediate layer is welded to the other layers of the laminate, in particular via at least one ultrasonic weld seam. Thereby, cumbersome positioning is eliminated, such as for the material strips of DE 20 300 781 U1. So, from a manufacture's point of view, too, the vacuum cleaner filter bag according to the invention offers advantages.

In the sense of the present invention, a non-woven fabric here designates an entangled mesh that has undergone a solidification step so that it has sufficient strength to be wound off or up into rolls, for example by machines (i. e. on an industrial scale). The minimum web tension required for winding up is 0.044 N/mm. The web tension should not be higher than 10% to 25% of the minimum maximum tensile force (according to DIN EN 29073-3:1992-08) of the material to be wound up. This results in a minimum maximum tensile force for a material to be wound up of 8.8 N per 5 cm of the strip width.

A fibrous web, briefly only referred to as “web”, corresponds to an entangled mesh which, however, has not undergone a solidification step, so that in contrast to a non-woven fabric, such an entangled mesh does not have sufficient strength to be wound off or up, respectively, into rolls, for example, by machines.

The term non-woven fabric (“non-woven”) is used, in other words, according to the definition of ISO Standard ISO9092:1988 or CEM Standard EN29092. Details of the use of the definitions and/or methods described herein can also be taken from the standard work “Vliesstoffe”, W. Albrecht, H. Fuchs, W. Kittelmann, Wiley-VCH, 2000.

For the at least one intermediate layer, both a non-woven fabric and a fibrous web can be employed.

The at least one intermediate layer may in particular be made of a staple fibre non-woven fabric or an extrusion non-woven fabric. In case of a staple fibre non-woven fabric, the intermediate layer correspondingly comprises fibres, in case of an extrusion non-woven fabric, so-called filaments. Correspondingly, staple fibre non-wovens or extrusion non-wovens are also possible.

In case of an extrusion non-woven fabric, in particular a filament spunbond (spunbond) is possible, in particular a coarse, very open filament spunbond.

The fibres or filaments of the at least one intermediate layer can have a larger average diameter than the fibres or filaments of the other layers of the bag wall, in particular the fine filter layer. In particular, the fibres or filaments of the at least one intermediate layer can have an average diameter of more than 5 μm, in particular of 10 μm to 100 μm, in particular of 30 μm to 100 μm. The average filament diameter of the fine filter layer may be, in contrast, less than 5 μm.

The average diameter of the fibres or filaments may be measured microscopically, in particular by light or scanning electron microscopy. In particular, the average diameter of the fibres or filaments of a layer, in particular the at least one intermediate layer, can be determined as follows: One takes at least ten samples of the layer to be examined, each sample corresponding to a round section of the layer to be examined, for example of the size of the sample support of the microscope. For example, each section can be a disk having a diameter of 12.5 mm. The thickness of the respective sample corresponds to the thickness of the layer to be examined. The respective sample is then examined in a plan view onto the circular surface. For each sample, one or more photographs are made in particular by means of a scanning electron microscope with 250× magnification. In case of a plurality of photographs, these should be taken from not overlapping partial regions of the sample. For each sample, the diameter is determined in the one or the plurality of photographs for all fibres/filaments. The number of the at least ten samples and/or the number of photographs per sample are selected such that at least 500 measured values of the diameter are obtained. From these at least 500 measured values, a non-weighted arithmetic average is then calculated which corresponds to the average diameter of the fibres/filaments.

For the fine filter layer, the same procedure is applied in principle. However, due to the fineness of the filaments, a 1000× magnification has to be applied here.

The measurements can be made, for example, with a “Phenom ProX scanning electron microscope (SEM)” of the company “Thermo Fisher Scientific”. The measuring of the fibres/filaments can be performed with the program “FiberMetric”, also of the company “Thermo Fisher Scientific”, which is available for this purpose.

The air permeability of the at least one intermediate layer can be more than 20001/m²/s, in particular more than 40001/m²/s, in particular more than 80001/m²/s. This can ensure that the filter-related properties of the laminate are not degraded by the intermediate layer.

The grammage of the at least one intermediate layer can be between 5 and 50 g/m².

The at least one intermediate layer can be a relatively coarse non-woven fabric or a relatively coarse fibrous web. By the spatially more concentrated material distribution, a deeper penetration of the fine filter layer can be achieved during welding. Moreover, the coarse fibres act as energy directors for the ultrasonic sound. In addition, the air permeability of such a coarse material is higher than for a finer material of the same weight.

The melt flow index (MFI) of the fibres or filaments of the at least one intermediate layer can be less than 100 g/10 min, in particular less than 50 g/10 min. So, the material as a melt is viscous and can thus permit a more stable connection. The MFI of the material of the fine filter layer is between 400 and 1500 g/10 min. This corresponds to the typical MFI for PP, for example, of a meltblown. The melt of such a PP is similar to that of water with respect to viscosity.

The melt flow index, also referred to as melt mass-flow rate, serves to characterize the flow properties of a plastic at predetermined pressure and temperature conditions. In other words, the melt flow index is a measure for the flow property of a plastic melt.

The melt flow index is defined according to ISO 1133 and is measured by means of a capillary rheometer. The melt flow index indicates the mass of thermoplastic melt pressed through a predetermined nozzle within 10 minutes under a predetermined pressure application.

The at least one intermediate layer can in particular directly be adjacent to the fine filter layer. In other words, the layers of the bag wall can be arranged such that between the fine filter layer and the intermediate layer, or between the fine filter layer and the capacity layer, respectively, there is no further layer. Moreover, the at least one intermediate layer can directly be adjacent to the support layer or the capacity layer, respectively, so that between the intermediate layer and the support layer, or between the intermediate layer and the capacity layer, respectively, there is neither any further layer arranged. Thereby, a particularly advantageous connection of the layers with each other and thus a stable weld seam can be achieved.

A protective layer, which is made of a non-woven fabric comprising recycled plastic, can join the capacity layer towards the bag's interior.

The protective layer can in particular be formed corresponding to the at least one intermediate layer. In other words, the protective layer can be made of the same non-woven fabric as the at least one intermediate layer, that means a non-woven fabric with rPP as a main component. The protective layer can also assume a function comparable to that of an intermediate layer, in particular if during the finishing of the vacuum cleaner filter bag, the protective layer abuts against a further non-woven fabric layer and is welded thereto.

The support layer can in particular be a spunbond which comprises rPET as a main component or consists thereof.

The non-woven fabric of the at least one intermediate layer can comprise a carded material. As a bonding step, mechanical methods (e. g. needling) as well as thermal methods (e. g. calendaring) are possible. Equally, the use of binding fibres or adhesives, such as a latex adhesive, is possible. Coarse extrusion non-woven fabrics, e. g. spunbonds, or airlaid materials are also possible.

The non-woven fabric of the at least one intermediate layer can comprise bicomponent fibres. Bicomponent fibres (bico fibres) can be formed of a core and an envelope enclosing the core. In this case, in particular the core can be formed of rPET and the envelope of rPP, or vice versa, the core can be formed of rPP and the envelope of rPET. Apart from core/envelope bicomponent fibres, the other common variations of bicomponent fibres, e. g. side-by-side, can be employed.

The bicomponent fibres can be present as staple fibres or be formed as filaments in an extrusion non-woven fabric (for example meltblown non-woven fabric).

The vacuum cleaner filter bag can moreover comprise a holding plate. The holding plate can be attachable to a holding means in a vacuum cleaner housing. Thereby, the holding plate can be arrangeable, in particular fixable, in a predetermined position within the vacuum cleaner housing. The holding plate can comprise a through-opening which is aligned with a through-opening in the bag wall, so that an admission port is formed through which the air to be cleaned can flow into the interior of the vacuum cleaner filter bag.

The holding plate can also comprise a recycled plastic or consist of one or more recycled plastics. In particular, the holding plate can comprise rPP and/or rPET, or consist thereof.

The holding plate can in particular be welded to the bag wall. In particular, between the holding plate and the outermost layer of the bag wall, in particular the support layer, a non-woven fabric element can be arranged as a bonding means. The non-woven fabric element, via which the holding plate is welded to the bag wall, can in particular comprise rPP and/or rPET. The non-woven fabric element can in particular be made of the same material as the intermediate layer.

It is also possible that a thermoplastic foil is arranged as a seal between the holding plate and the bag wall. Depending on the material of the outer layer of the bag wall and the holding plate, the thermoplastic elastomer (TPE) of the sealing element can be a TPE on the basis of PP or on the basis of PET. The material should be matched to each other, i. e. in a holding plate and an outer layer with PET as a main component, the sealing material should also comprise PET as a main component, or PP if the holding plate and the outer layer comprise PP as a main component.

It is furthermore possible that in the interior, at least one flow distributor and/or at least one diffuser is arranged, wherein preferably the at least one flow distributor and/or the at least one diffuser is formed of a recycled plastic or a plurality of recycled plastics. Such flow distributors or diffusers are known, e. g. from patent applications EP 2 263 508, EP 2 442 703, DE 20 2006 020 047, DE 20 2008 003 248, DE 20 2008 005 050. The vacuum cleaner filter bags according to the invention, including the flow distributor, can be also correspondingly designed.

Flow distributors and diffusers are preferably also made of non-woven fabrics or laminates of non-woven fabrics. For these elements, preferably, the same materials can be used as for the capacity and reinforcement layers (the latter also being referred to as support or protective layers).

In a further preferred embodiment, the parts by weight of all recycled materials, based on the total weight of the vacuum cleaner filter bag, are at least 25%, preferably at least 30%, further preferred at least 40%, further preferred at least 50%, further preferred at least 60%, further preferred at least 70%, further preferred at least 80%, further preferred at least 90%, in particular at least 95%. Thus, the requirements of the Global Recycled Standard (GRS), v3 (August 2014) of Textile Exchange can be achieved.

The vacuum cleaner filter bag according to the present invention can be formed, for example, in the form of a flat bag, a gusset bag, a block bottom bag or a 3D bag, such as, for example, a vacuum cleaner filter bag for an upright vacuum cleaner. A flat bag has no side walls and is formed of two material layers, the two material layers being directly connected to each other along their circumference, for example welded or glued. Each one of the material layers can be a laminate, that means it can comprise itself a plurality of non-woven fabric layers or web and non-woven fabric layers. Gusset bags are a modified form of a flat bag and comprise fixed side folds or side folds, which can be turned out. Block bottom bags comprise a so-called block or pad bottom which in most cases forms the narrow side of the vacuum cleaner filter bag; on this side, a holding plate is typically arranged.

For many plastic recyclates, there are relevant international standards. For PET plastic recyclates, for example, DIN EN 15353:2007 is relevant. PP recyclates are characterised in DIN EN 15345:2008. For the purpose of the corresponding special plastic recyclates, the present patent application adopts the definitions of these international standards. The plastic recyclates can be non-metallised. One example of this are plastic flakes or chips recovered from PET beverage bottles. Equally, the plastic recyclates can be metallised, e. g. if the recyclates have been obtained from metallic plastic foils, in particular metallised PET foils (MPET).

Recycled polyethylene terephthalate (rPET) can be obtained, for example, from beverage bottles, in particular so-called bottle flakes, that means pieces of ground beverage bottles.

The recycled plastics, in particular the recycled PET and/or the recycled PP, both in the metallised and in the non-metallised version, can be spun into the corresponding fibres from which the corresponding staple fibres or meltblown or spunbond non-woven fabrics can be manufactured for the purposes of the present invention.

When recycled plastics are mentioned herein, an “r” precedes the abbreviation, for example rPP or rPET. When abbreviations without a preceding “r” are used herein, this designates the new plastic materials (virgin plastics).

The recycled material from the manufacture of textiles (TLO), which can in particular be employed for the capacity layer, is in particular generated in the processing of textile materials (in particular textile fibres and filaments, and linear, planiform and spatial textile fabrics manufactured therewith), such as, for example, the manufacture (comprising carding, spinning, cutting, and drying) or the recycling of textile materials. These pulverized and/or fibrous materials are waste materials which can deposit on the machines or filter materials used for processing the textiles. The dusts (powders) or fibres are normally disposed of and thermally utilised.

The pulverized and/or fibrous recycled material is, for example, production waste; this in particular applies to material generated during the carding, spinning, cutting, or drying of textile materials as a waste product. This is also referred to as “pre-consumer waste”.

In the recycling of textile materials, i. e. the processing (for example crushing) of used textile materials or textiles (for example old clothes), pulverized and/or fibrous recycled material is also formed, this is referred to as “post-consumer waste”.

So, the recycled material from the manufacture of textiles, TLO, can comprise, in particular, fibres and/or filaments which have been obtained from waste materials from the textile and clothing industry, from post-consumer waste (textiles or the like), and/or from products that have been collected for recycling.

The invention moreover provides a method of manufacturing a vacuum cleaner filter bag according to claim 12.

By the laminate comprising at least one intermediate layer of non-woven fabric or fibrous web with rPP as a main component, as illustrated above, an improvement of the weld seam strength can be achieved.

The layers of the laminate can comprise one or more of the above-mentioned features.

The finishing of the non-woven laminate can moreover comprise the formation of at least one weld seam, and the method can moreover comprise a precompaction of the non-woven fabric laminate in at least one region where the at least one weld seam is formed. It has been found that by such a welding in two steps, that means precompaction before the actual welding, a further improvement of the weld seam strength can be achieved.

Precompaction can be accomplished by ultrasonic welding, thermal welding, or by pressurization. Pressurization here means the application of pressure without heating (that means cold) and without introducing ultrasonic energy.

In particular, only a portion of two parts to be connected by a weld seam can be precompacted. This reduces the amount of required equipment.

The method can moreover comprise punching a through-opening into the non-woven laminate, and arranging a non-woven fabric element and a holding plate in the region of the through-opening, and welding the holding plate to the material web over the non-woven fabric element.

The precompaction can also be employed in the region of the bag wall which is connected to the holding plate. To this end, first of all, an annular region of the bag wall is precompacted. In subsequent steps, the through-opening is punched, and the holding plate is welded on in the region of the precompacted, annular region.

The non-woven fabric laminate can be provided in the form of a first and a second material web. The finishing of the vacuum cleaner filter bag can then comprise overlapping the material webs and forming two opposite longitudinal weld seams extending in the machine direction and two opposite transverse weld seams extending transverse to the machine direction by ultrasonic welding, and separating the bag formed in this manner in the region of the transverse weld seams. In this manner, a flat bag can be manufactured.

As illustrated above, before the formation of the weld seams, one or both material webs can be precompacted in the region where the respective weld seam is formed.

The method can moreover comprise forming side folds, so that a gusset bag is formed.

The invention moreover provides a vacuum cleaner filter bag according to claim 16. The latter also realises the inventive idea of the at least one intermediate layer, but has a simpler design than the vacuum cleaner filter bag of claim 1, as a capacity layer can be eliminated.

The at least one intermediate layer, the support layer, the fine filter layer, and the protective layer can each comprise one or more of the above-described features. The rest of the vacuum cleaner filter bag can, apart from the capacity layer, also comprise one or more of the above-described features.

In particular, the support layer and the protective layer can be formed as spunbond non-woven fabrics. In this case, the basic structure of spunbond-meltblown-spunbond (SMS) known per se results, which however, is supplemented by the at least one intermediate layer according to the invention.

The bag wall of the vacuum cleaner filter bag according to claim 16 can also comprise a plurality of fine filter layers, in particular in the form of meltblown non-woven fabrics.

The invention moreover provides a method of manufacturing a vacuum cleaner filter bag according to claim 17. This can in particular be a method of manufacturing a vacuum cleaner filter bag according to claim 16. The method can comprise, apart from the missing capacity layer, one or more of the above-described features of the method according to claim 12.

Further features and advantages of the invention will be illustrated below with reference to the exemplary figures. In the figures:

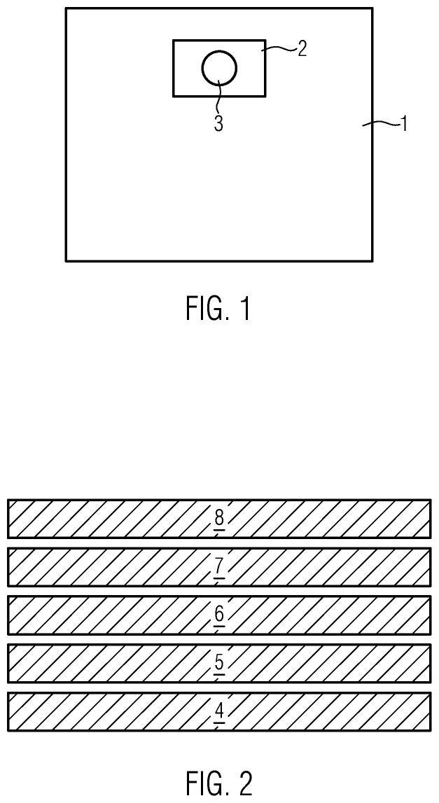

FIG. 1 schematically shows the structure of an exemplary vacuum cleaner filter bag; and

FIG. 2 shows the schematic structure of the bag wall of an exemplary vacuum cleaner filter bag in a cross-section.

FIG. 1 shows the schematic structure of an exemplary vacuum cleaner filter bag. The filter bag comprises a bag wall 1, a holding plate 2 and an admission port through which the air to be filtered flows into the filter bag. The admission port is here formed by a through-opening 3 in the base plate of the holding plate 2 and a through-opening in the bag wall 1 aligned with it. The holding plate 2 is used for fixing the vacuum cleaner filter bag in a corresponding mounting in a housing of a vacuum cleaner.

The bag wall 1 comprises a plurality of non-woven fabric layers or a plurality of non-woven fabric and fibrous web layers which overlap each other from the bag's interior to the bag's exterior. The non-woven fabric or fibrous web layers can loosely lie one upon the other or be connected to each other. The connections can be accomplished across the surface (e. g. via spray adhesives), or punctually (e. g. via a calendaring pattern).

The individual layers can in particular comprise different plastic materials, both among each other and/or within one respective layer.

The exemplary vacuum cleaner filter bag of FIG. 1 is a so-called flat bag wherein the bag wall comprises an upper side and a bottom side which are connected to each other by a surrounding weld seam. Both the upper side and the bottom side of the flat bag comprise, as mentioned above, a plurality of filter material layers, in particular a plurality of non-woven fabric layers or a plurality of non-woven fabric and fibrous web layers. Both the upper side and the bottom side can in particular be formed of a laminate of a plurality of non-woven fabric layers. However, the invention is not limited to flat bags but can also be applied, for example, to gusset bags or pad bottom bags.

Advantageously, the holding plate 2 in this example comprises a base plate of a recycled plastic material, for example, recycled polypropylene (rPP) or recycled polyethylene terephthalate (rPET).

In the operation of such a vacuum cleaner filter bag, the weld seam strength for the surrounding weld seam is of particular importance.

FIG. 2 illustrates an exemplary structure of the bag wall which leads to an increase of the weld seam strength compared to known vacuum cleaner filter bags.

FIG. 2 in particular shows a section through the bag wall of an exemplary vacuum cleaner filter bag, for example through the upper side of the flat bag of FIG. 1. Here, the layer 4 is arranged towards the bag's interior, and the layer 8 is arranged at the outer side of the vacuum cleaner filter bag.

The layer 4 is a protective layer which can be formed of a non-woven fabric of any recycled fibres or filaments. For example, the protective layer can be formed of a non-woven fabric which comprises rPP and/or rPET, or consists thereof. In particular, the protective layer 4 can be a spunbond.

As a raw material, for example PET waste (e. g. punchings) and so-called bottle flakes, i. e. pieces of ground beverage bottles, can be used. To cover the different colours of the waste, it is possible to colour the recyclate. As a thermal bonding method for the solidification of the spunlaid web into a spunbond, in particular the HELIX® (Comerio Ercole) method is advantageous.

Adjacent to the protective layer, a capacity layer 5 is arranged. The capacity layer 5 offers high resistance against impact loads and permits a filtering of large dirt particles, a filtering of a significant proportion of small dust particles, and a storage or retention of high amounts of particles, the air being allowed to flow through easily, thus resulting in a low pressure drop with a high particle load. The capacity layer can in particular comprise a fibrous web and/or a non-woven fabric which comprises pulverized and/or fibrous recycled material from the manufacture of textiles (TLO), or consists thereof. The capacity layer 5 can also comprise rPET and/or rPP or consist thereof.

The capacity layer 5 preferably comprises a basis weight of 5 to 200 g/m², in particular of 10 to 150 g/m², in particular of 20 to 100 g/m², in particular of 30 to 50 g/m².

Towards the exterior of the bag wall, a fine filter layer 6 is adjacent to the capacity layer 5. The fine filter layer 6 is, in this example, an extrusion non-woven fabric, in particular a meltblown non-woven fabric. The fine filter layer 6 can in particular comprise (virgin) polypropylene, bicomponent fibres of (virgin) polypropylene and (virgin) polyethylene terephthalate, and/or bicomponent fibres of (virgin) polypropylene and recycled polypropylene, or consist thereof.

A fine filter layer 6 serves to increase the filtration performance of the multi-layer filter material by capturing particles which penetrate, for example, the protective layer 4 and/or the capacity layer 5. To further increase the separation performance, the fine filter layer 6 can be preferably charged electrostatically (e. g. by corona discharge or hydro-charging), in particular to increase the separation of particulate matter.

According to an advantageous embodiment, the fine filter layer 6 has a basis weight of 5 to 100 g/m², in particular of 10 to 50 g/m², in particular of 10 to 30 g/m².

Grammage (basis weight) is determined according to DIN EN 29073-1: 1992-08.

The layer arranged in this schematic example at the outermost position is the support layer 8. A support layer (sometimes also referred to as “reinforcement layer”) is here a layer that imparts the required mechanical strength to the multi-layer bond of the filter material. The support layer can in particular be an open, porous non-woven fabric with a light grammage. The support layer 8 can in particular be a spunbond which comprises rPET or consists thereof.

WO 01/003802 offers an overview of the individual functional layers within multi-layer filter materials for vacuum cleaner filter bags.

According to an exemplified embodiment of the invention, between the support layer 8 and the fine filter layer 6, an intermediate layer 7 is arranged which is made of a non-woven fabric comprising rPP as a main component. The intermediate layer 7 can be a non-woven fabric layer of a staple fibre non-woven fabric or an extrusion non-woven fabric. It has surprisingly been found that such an intermediate layer essentially improves the weld seam strength of the filter bag. Instead of a non-woven fabric, a fibrous web can also be used for the intermediate layer 7. This is because an intrinsic strength of the intermediate layer is not required.

A particularly advantageous improvement of the maximum tensile force of the weld seams (here briefly referred to as “weld seam strength”) can be achieved if the grammage of the intermediate layer 7 is between 5 and 50 g/m², and simultaneously the average diameter of the fibres or filaments is at least 5 μm, in particular between 10 μm and 100 μm. Such a non-woven fabric is relatively coarse. Air permeability can be at least 4000 l/m²/s.

Air permeability is determined according to DIN EN ISO 9237: 1995-12. The air permeability test apparatus FX3300 by Texttest AG can be employed. In particular, a differential pressure of 200 Pa and a test area of 25 cm² can be employed.

The determination of the maximum tensile force can be performed in accordance with DIN EN 29073-3: 1992-08, in particular with a strip of a width of 5 cm.

The melt flow index of the material of the intermediate layer, in particular the employed rPP, can be less than 100 g/10 min. Thereby, the maximum tensile force of the weld seams can be further increased.

A further improvement of the weld seam strength can be achieved if welding is performed in two steps. In a first step, in particular one or both material webs which are used for manufacturing the flat bag can be precompacted in the welding region. This precompaction can be accomplished by ultrasonic welding, thermal welding, or by pressurization. In particular, the sonotrode can be placed onto the exterior of the laminate during precompaction, that means be in direct contact with the support layer 8.

The sonotrodes and anvils used for welding can have a smooth surface. However, it is advantageous for the sonotrode and/or the anvil to comprise a high-low structure for the welding operation, that means that the surface is provided with a relief. For precompaction, a surface smooth on both sides or a lower structuring is advantageous. However, for precompaction, too, the sonotrode and/or anvil employed can comprise a high-low structure, that means the surface is provided with a relief.

A further, second intermediate layer not shown in the figures can be provided between the fine filter layer 6 and the capacity layer 5. The second intermediate layer can be embodied corresponding to the first intermediate layer 7, but it can also differ from the intermediate layer 7 in one or more features. It is only essential that the second intermediate layer, too, is made of a non-woven fabric or a fibrous web which comprises rPP as a main component. Preferably, the grammage of the second intermediate layer is also between 5 and 50 g/m², and simultaneously, the average diameter of the fibres or filaments is at least 5 μm, in particular between 10 μm and 100 μm. The melt flow index of the material of the intermediate layer, in particular the employed rPP, can also be less than 100 g/10 min.

The capacity layer 5 can also be eliminated according to an alternative, or be replaced by a further intermediate layer or a further fine filter layer.

To illustrate the effect of intermediate layers of rPP, the following comparative measurements have been made:

| | | | Embodiment in |
|---|---|---|---|
| | | | accordance with |
| Variant | Comparative Example 1 | Comparative Example 2 | the invention |
| Material | Support layer: | Support layer: | Support layer: |
| structure | rPET spunbond 40 g/m² | rPET spunbond 40 g/m² | rPET spunbond 40 g/m² |
| | Fine filter layer: | Fine filter layer: | Intermediate layer: |
| | PP Meltblown 20 g/m² | PP Meltblown 40 g/m² | rPP carded 20 g/m² |
| | Capacity layer: | Capacity layer: | Fine filter layer: |
| | carded non-woven | carded non-woven fabric | PP Meltblown 40 g/m² |
| | fabric with TLO 90 g/m² | with TLO 90 g/m² | Intermediate layer: |
| | | | rPP carded 20 g/m² |
| | | | Capacity layer: |
| | | | carded non-woven fabric |
| | | | with TLO 90 g/m² |
| Welding | 2400 W, 4 bar, 260 J, | 2400 W, 4 bar, 260 J, | 2400 W, 4 bar, 260 J, |
| parameters | 70% amplitude | 70% amplitude | 70% amplitude |
| Maximum | Average value of 10 | Average value of 10 | Average value of 10 |
| tensile | measurements: | measurements: | measurements: |
| force weld | 32.9N | 44.4N | 75.4N |
| seam at 5 | | | |
| cm strip | | | |
| width | | | |

The influence of an optional precompaction will be obvious from the following measurements:

| | | |
|---|---|---|
| Material | Support layer: | Support layer: |
| structure | rPET spunbond 50 g/m2 | rPET spunbond 50 g/m2 |
| | Intermediate layer: | Intermediate layer: |
| | rPP carded 20 g/m² | rPP carded 20 g/m² |
| | Fine filter layer: | Fine filter layer: |
| | PP Meltblown 20 g/m² | PP Meltblown 20 g/m² |
| | Intermediate layer: | Intermediate layer: |
| | rPP carded 20 g/m² | rPP carded 20 g/m² |
| | Capacity layer: | Capacity layer: |
| | carded non-woven fabric with TLO | carded non-woven fabric with TLO |
| | 90 g/m² | 90 g/m² |
| Welding | 2400 W, 4 bar, 260 J, 70% | 1. Precompaction with 2400 W, 4 bar |
| parameters | amplitude | and 200 J, 70% amplitude |
| | | 2. Welding with 2400 W, 4 bar 260 J, |
| | | 70% amplitude |
| Maximum | Average value of 10 measurements: | Average value of 10 measurements: |
| tensile force | 75.4N | 85.4N |
| weld seam at | | |
| 5 cm strip | | |
| width | | |

It will be understood that features mentioned in the above-described embodiments are not restricted to these special combinations and are also possible in any other combinations. It will be furthermore understood that geometries shown in the figures are only given by way of example and are also possible in any other embodiments.

1. A vacuum cleaner filter bag with a bag wall, comprising:
a support layer comprising a recycled polyethylene terephthalate, rPET;
a fine filter layer of a meltblown non-woven fabric comprising a polypropylene, PP, a PET and/or a recycled polypropylene, rPP; and
a capacity layer of a non-woven fabric comprising a rPET, a recycled textile material, a TLO, and/or an rPP;
wherein the bag wall further comprises at least one intermediate layer formed of a non-woven fabric or a fibrous web and comprising an rPP as a main component; and
wherein the at least one intermediate layer is arranged between the support layer and the fine filter layer and/or between the fine filter layer and the capacity layer.

2. The vacuum cleaner filter bag according to claim 1, wherein the at least one intermediate layer is made of a staple fibre non-woven fabric or a staple fibre web, or an extrusion non-woven fabric or an extrusion web.

3. The vacuum cleaner filter bag according to claim 1, wherein fibres or filaments of the non-woven fabric or the fibrous web of the at least one intermediate layer have an average diameter of more than 5 μm.

4. The vacuum cleaner filter bag according to claim 1, wherein an air permeability of the at least one intermediate layer is more than 2000 l/m²/s.

5. The vacuum cleaner filter bag according to claim 1, wherein a grammage of the at least one intermediate layer is between 5 and 50 g/m².

6. The vacuum cleaner filter bag according to claim 1, wherein the non-woven fabric or the fibrous web of the at least one intermediate layer comprises a melt flow index of less than 100 g/10 min.

7. The vacuum cleaner filter bag according to claim 1, wherein the at least one intermediate layer is directly adjacent to the fine filter layer.

8. The vacuum cleaner filter bag according to claim 1, wherein a protective layer is directly adjacent to the capacity layer towards an interior of the bag which is made of a non-woven fabric comprising a recycled plastic.

9. The vacuum cleaner filter bag according to claim 8, wherein the protective layer is embodied corresponding to the intermediate layer.

10. The vacuum cleaner filter bag according to claim 1, wherein the support layer is a spunbond of the rPET.

11. The vacuum cleaner filter bag according to claim 1, wherein the non-woven fabric of the at least one intermediate layer comprises bicomponent fibres.

12. A method of manufacturing a vacuum cleaner filter bag, comprising the steps of:
providing a non-woven fabric laminate, comprising:
a support layer comprising a recycled polyethylene terephthalate, rPET;
a fine filter layer of a meltblown non-woven fabric comprising a polypropylene, PP, a PET, and/or a recycled polypropylene, rPP;
a capacity layer of a non-woven fabric comprising an rPET, a recycled textile material, a TLO, and/or an rPP; and
at least one intermediate layer formed of a non-woven fabric or a fibrous web and comprising an rPP as a main component, wherein the at least one intermediate layer is arranged between the support layer and the fine filter layer and/or between the fine filter layer and the capacity layer; and
finishing the non-woven fabric laminate to the vacuum cleaner filter bag.

13. The method according to claim 12, wherein the finishing of the non-woven fabric laminate comprises forming at least one weld seam, and wherein the method further comprises a precompaction of the non-woven fabric laminate in at least one region where the at least one weld seam is formed.

14. The method according to claim 13, wherein the precompaction is accomplished by ultrasonic welding, thermal welding or by pressurization.

15. The method according to claim 13, wherein a sonotrode is arranged, during the precompaction, at the support layer or a side of the laminate located closer to the support layer.

16. A vacuum cleaner filter bag with a bag wall, comprising:
a support layer comprising a recycled polyethylene terephthalate, rPET;
a fine filter layer of a meltblown non-woven fabric comprising polypropylene, PP, a PET, and/or a recycled polypropylene, rPP; and
a protective layer made of a non-woven fabric comprising a recycled plastic;
wherein the bag wall further comprises at least one intermediate layer formed of a non-woven fabric or a fibrous web and comprising an rPP as a main component; and
wherein the at least one intermediate layer is arranged between the support layer and the fine filter layer and/or between the fine filter layer and the protective layer.

17. A method of manufacturing a vacuum cleaner filter bag, comprising the steps of:
providing a non-woven fabric laminate, comprising:
a support layer comprising a recycled polyethylene terephthalate, rPET;
a fine filter layer of a meltblown non-woven fabric comprising a polypropylene, PP, a PET and/or a recycled polypropylene, rPP;
a protective layer made of a non-woven fabric comprising a recycled plastic; and
at least one intermediate layer formed of a non-woven fabric or a fibrous web and comprising an rPP as a main component, wherein the at least one intermediate layer is arranged between the support layer and the fine filter layer and/or between the fine filter layer and the protective layer; and
finishing the non-woven fabric laminate into a vacuum cleaner filter bag.

18. The vacuum cleaner filter bag according to claim 3, wherein the fibres or filaments of the non-woven fabric or the fibrous web of the at least one intermediate layer have an average diameter between 10 μm to 100 μm.

19. The vacuum cleaner filter bag according to claim 4, wherein the air permeability of the at least one intermediate layer is more than 800 l/m²/s.

20. The vacuum cleaner filter bag according to claim 11, wherein the biocomponent fibres comprise a core comprising an rPET and an envelope comprising an rPP or vice-versa.
